(19) United States
(12) Patent Application Publication
(10) Pub. No.: US 2023/0309165 A1
(43) Pub. Date: Sep. 28, 2023

(54) USER TERMINAL, BASE STATION, AND RADIO COMMUNICATION METHOD

(71) Applicant: SOFTBANK CORP., Tokyo (JP)

(72) Inventor: Masashi FUSHIKI, Tokyo (JP)

(21) Appl. No.: 18/020,583

(22) PCT Filed: Sep. 25, 2020
(86) PCT No.: PCT/JP2020/036381

§ 371 Date: Feb. 9, 2023

(51) Int. Cl. H04W 76/15; H04W 16/14; H04L 5/00; H04W 52/36

(52) U.S. Cl. CPC H04W 76/15; H04W 16/14; H04L 5/0046; H04W 52/367

(57) ABSTRACT

Communication in a non-co-located scenario is controlled appropriately. A user terminal includes: a receiving unit that receives a downlink signal from a plurality of transmission points respectively corresponding to a plurality of cells by using carrier aggregation and/or dual connectivity; a transmission unit that transmits information about support for required conditions when the plurality of transmission points are not co-located; and a control unit that controls the reception of the downlink signal on the basis of whether the plurality of transmission points are co-located or not.

### TECHNICAL FIELD

The present invention relates to a user terminal, a base station, and a radio communication method.

### BACKGROUND ART

Regarding the 3GPP (Third Generation Partnership Project), which is an international standardizing body, Release 15 of NR (New Radio), which is a radio access technology (Radio Access Technology: RAT) for the 5th generation (Fifth Generation: 5G), is specified (for example, NPL 1) as a successor to LTE (Long Term Evolution); which is a RAT for the 3.9th generation, and LTE-Advance, which is a RAT for the 4th generation. Regarding the 3GPP, Release 16 and subsequent releases of NR are being discussed.

Release 15 has introduced carrier aggregation (Carrier Aggregation: CA) to widen bandwidth by integrating a plurality of cells together. Moreover, Release 15 has introduced dual connectivity (Dual Connectivity: DC) to make a user terminal connect to a plurality of cell groups, each of which includes one or more cells.

### CITATION LIST

### Non-Patent Literature

NPL 1: 3GPP TS 38.300 V15.9.0 (2020-03)

### SUMMARY OF THE INVENTION

### Technical Problem

With Release 16, it is assumed that the above-mentioned CA and/or DC (hereinafter referred to as “CA/DC”) takes place in a scenario where a plurality of transmission points (Transmission Points: TP) respectively corresponding to a plurality of cells are co-located (hereinafter referred to as the “co-located scenario”).

Meanwhile, regarding Release 17 and subsequent releases, the above-mentioned CA/DC taking place not only in the co-located scenario, but also in a scenario where the plurality of transmission points respectively corresponding to the plurality of cells are not co-located (hereinafter referred to as the “non-co-located scenario”) is being discussed.

The present invention was devised in light of the above-described circumstances, and it is one of objects to provide a user terminal, a base station, and a radio communication method which are capable of controlling the communication in the non-co-located scenario.

### Solution to Problem

A user terminal according to one aspect of the present invention includes: a receiving unit that receives a downlink signal from a plurality of transmission points respectively corresponding to a plurality of cells by using carrier aggregation and/or dual connectivity; a transmission unit that transmits information about support for required conditions when the plurality of transmission points are not co-located; and a control unit that controls the reception of the downlink signal on the basis of whether the plurality of transmission points are co-located or not.

A base station according to another aspect of the present invention includes: a transmission unit that transmits a downlink signal from a plurality of transmission points respectively corresponding to a plurality of cells by using carrier aggregation and/or dual connectivity; a receiving unit that receives information about support for required conditions when the plurality of transmission points are not co-located; and a control unit that controls the carrier aggregation or the dual connectivity on the basis of the information about the support.

### Advantageous Effects of the Invention

The communication in the non-co-located scenario can be controlled appropriately according to the present invention.

### BRIEF DESCRIPTION OF DRAWINGS

FIG. 1 is a diagram illustrating an example of the outline of a radio communication system according to this embodiment;

FIG. 2 is a diagram illustrating an example of inter-band CA/DC according to this embodiment;

FIG. 3 is a diagram illustrating an example of intra-band CA/DC according to this embodiment;

FIG. 4 is a diagram illustrating an example of a co-located scenario according to this embodiment;

FIG. 5 is a diagram illustrating an example of a non-co-located scenario according to this embodiment;

FIG. 6A is a diagram illustrating an example of required conditions for the reception timing difference in the CA according to this embodiment;

FIG. 6B is a diagram illustrating an example of required conditions for the reception timing difference in the DC according to this embodiment;

FIG. 7A is a diagram illustrating an example of required conditions for the received electric power difference in the CA according to this embodiment;

FIG. 7B is a diagram illustrating an example of required conditions for the received electric power difference in the DC according to this embodiment;

FIG. 8 is a diagram illustrating an example of a hardware configuration of each apparatus in a radio communication system according to this embodiment;

FIG. 9 is a diagram illustrating an example of a functional block configuration of a user terminal according to this embodiment;

FIG. 10 is a diagram illustrating an example of a functional block configuration of a base station according to this embodiment;

FIG. 11 is a diagram illustrating an example of a first operation in the CA/DC according to this embodiment; and

FIG. 12 is a diagram illustrating an example of a second operation in the CA/DC according to this embodiment.

### DESCRIPTION OF EMBODIMENTS

Embodiments of the present invention will be explained with reference to the attached drawings. It should be noted that in each drawing, elements to which the same reference numeral is assigned may have the same configuration or similar configurations.

(Outline of Radio Communication System)

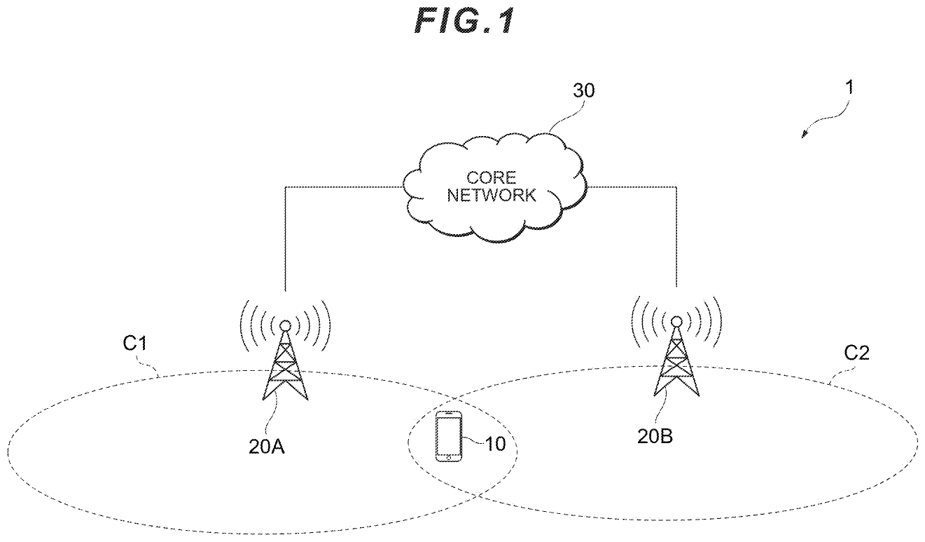

FIG. 1 is a diagram illustrating an example of the outline of a radio communication system according to this embodiment. The radio communication system 1 may include a user terminal 10, base stations 20A and 20B, and a core network 30 as illustrated in FIG. 1. Incidentally, when no distinguishment is made between the base stations 20A and 20B and between the cells C1 and C2, they will be respectively collectively referred to as the base station(s) 20 and the cell(s) C. Furthermore, the number of the user terminal(s) 10 and the number of the base stations 20 illustrated in FIG. 1 are just examples and are not limited to the numbers indicated in the drawing.

The radio communication system 1 operates with one or a plurality of radio access technologies (RAT). For example, the radio communication system 1 may operate with either one of LTE, LTE-Advanced, or NR, or may operate with a plurality of RATs (multi-RAT) including LTE and/or LTE-Advanced, and NR. LTE and/or LTE-Advanced are also called “Evolved-Universal Terrestrial Radio Access (E-UTRA).”

Furthermore, the radio communication system 1 operates within one or a plurality of frequency ranges (FR). For example, the radio communication system 1 may operate within FR1 corresponding to 410 MHz to 7125 MHz and/or FR2 corresponding to 24,250 MHz to 52,600 MHz. Each FR includes one or more frequency bands. The frequency band(s) may be also called an operating band(s), a band(s), an NR operating band(s), an NR band(s), and so on.

Each frequency band is associated with a plurality of ARFCNs (Absolute Radio Frequency Channel Numbers). The ARFCN may identify a frequency at which a carrier is located within the relevant frequency band (hereinafter referred to as the “carrier frequency”), The carrier frequency is also called, for example, an RF reference frequency, an NR frequency, an E-UTRA frequency, a center frequency, a channel raster, or simply a frequency. Accordingly, the ARFCN and the carrier frequency are uniquely associated with each other. Furthermore, one carrier frequency may be used for one cell C or a plurality of cells C.

The user terminal 10 is, for example, a specified terminal or apparatus such as a smartphone, a personal computer, an in-vehicle terminal, an in-vehicle apparatus, or a static apparatus, etc. The user terminal 10 may be also called, for example, User Equipment (UE), The user terminal 10 may be of a mobile type or a fixed type. The user terminal 10 is configured to be capable of communication with, for example, at least one RAT among E-UTRA and NR.

The base station 20 forms one or more cells C. The cell(s) C may be also restated as, for example, a serving cell, a carrier, or a component carrier (Component Carrier: CC). Incidentally, in FIG. 1, the base stations 20A and 20B form the cells C1 and C2, respectively; however, without limitation to this example, each base station may form one or more cells C. Moreover, a plurality of base stations 20 may be connected via an ideal backhaul or a non-ideal backhaul. Furthermore, the plurality of base stations 20 may be connected via a specified interface (for example, an X2 or Xn interface).

The base station 20 communicates with the user terminal 10, The base station 20 may be also called, for example, an eNodeB (eNB), an ng-eNB, a gNodeB (gNB), an en-gNB, a Next Generation—Radio Access Network (NG-RAN) node, a Donor eNodeB (DeNB), a Donor eNodeB (DeNB), a Donor node, or a Central Unit, a low-power node, a pico eNB, a Home eNB (HeNB), a Distributed Unit (DU), a gNB-DU, a Remote Radio Head (RRH), an Integrated Access and Backhaul/Backhauling (IAB) node, a node, a master node (Master Node (MN)), or a secondary node (Secondary Node (SN)). Incidentally, the base station 20 which operates on NR is also called an “NR base station” and the base station 20 which operates on E-UTRA may also be called an “E-UTRA base station.”

The core network 30 is, for example, a core network compatible with E-UTRA (Evolved Packet Core: EPC) or a core network compatible with NR (5G Core Network: 5GC). An apparatus on the core network 30 (hereinafter also referred to as the “core network apparatus”) performs mobility management such as paging and position registration of the user terminal 10. The core network apparatus may be connected to the base station 20 via a specified interface (for example, an S1 or NG interface).

The core network apparatus may include, for example, at least one of a Mobility Management Entity (MME) which performs mobility management of the user terminal 10, an Access and Mobility Management Function (AMF) which manages C-plane information (such as information about access and mobility management), and a User Plane Function (UPF) which performs transmission control of U-plane information (such as user data).

<CA/DC>

In the radio communication system 1, the user terminal 10 receives a downlink (downlink: UL) signal and/or transmits an uplink signal (downlink: UL) by using carrier aggregation and/or dual connectivity (CA/DC).

Regarding the CA, the user terminal 10 receives the downlink signal and/or transmits the uplink signal at a plurality of cells C within the same cell group. The plurality of cells C may include one primary cell (Primary Cell: PCell) and one or more secondary cells (Secondary Cell: SCell), The PCell may be also called a special cell (Special Cell: SpCell). Moreover, the plurality of cells C may be associated with a single node (for example, a single medium access control (Medium Access Control (MAC) entity). Furthermore, the CA for which the RAT of the relevant plurality of cells C is NR may be also called an “NR-NR Carrier Aggregation (NR CA).”

Regarding the DC, the user terminal 10 receives the downlink signal and/or transmits the uplink signal at a plurality of cells C within different cell groups. For example, the user terminal receives the downlink signal and/or transmits the uplink signal at one or more cells C within a master cell group (Master Cell Group: MCG) and at one or more cells C within a secondary cell group (Secondary Cell Group: SCG). Each cell C within the MCG is also called an “MCG cell” and each cell C within the SCG is also called an “SCG cell.”

One or more MCG cells include at least a PCell and may include one or more SCells. One or more SCG cells include at least a primary SCG cell (Primary SCG Cell: PSCell) and may include one or more SCells. The PCell and the PSCell may be also called an SpCell. Furthermore, one or more MCG cells are associated with a master node (Master Node (MN)) and one or more SCG cells may be associated with a secondary node (Secondary Node (SN)). Each of the MN and the SN may have an MAC entity. It can be said that a plurality of cells C in each cell group (for example, MCG or SCG) are integrated together by the CA.

Regarding the DC, a plurality of nodes (such as MN and SN) which are respectively associated with a plurality of cell groups (such as MCG and SCG) may use the same RAT or may use different RATS.

For example, the DC where the user terminal 10 connects to an eNB which operates as an MN (i.e., an E-UTRA base station 20 connected to an EPC) and an en-gNB which operates as an SN (i.e., an NR base station 20 connected to the EPC) may be also called “E-UTRA-NR Dual Connectivity (EN-DC).”

Also, the DC where the user terminal 10 connects to a gNB which operates as an MN (i.e., an NR base station 20 connected to 5GC) and an ng-eNB which operates as an SN (i.e., an E-UTRA base station 20 connected to the 5GC) may be also called “NR-E-UTRA Dual Connectivity (NE-DC).”

Moreover, the DC where the user terminal 10 connects to an ng-eNB which operates as an MN (i.e., an E-UTRA base station 20 connected to the 5GC) and a gNB which operates as an SN (i.e., an NR base station 20 connected to the 5GC) may be also called “NG-RAN E-UTRA-NR Dual Connectivity (NGEN-DC).”

Furthermore, the DC where the user terminal 10 connects to a gNB which operates as an MN (i.e., an NR base station 20 connected to the 5GC) and a gNB (i.e., an NR base station 20 connected to the 5GC) may be also called “NR-NR Dual Connectivity (NR-DC).” Moreover, the DC where the user terminal 10 connects to two gNB-DUs which operate as an MN and an SN, respectively, may be also called NR-DC. The above-mentioned two gNB-DUs are connected to a gNB-CU. Incidentally, these two gNB-DUs and the gNB-CU may configure one base station 20.

Regarding the above-described CA/DC, the user terminal 10 may receive/transmit specified information (such as an RRC message or an RRC information element (RRC Information Element: RRC IE)) at an SpCell by using radio resource control (Radio Resource Control: RRC) signaling. Specifically, regarding the CA, RRC signaling is performed at a PCell; and regarding the DC, RRC signaling is performed at a PCell and a PSCell. Accordingly, regarding the CA/DC, an RRC entity may be provided for each node associated with a cell group.

Furthermore, regarding the CA/DC, a duplex mode of the plurality of cells C may be a frequency division duplex (Frequency Division Duplex: FDD), time division duplex (Time Division Duplex: TDD), or FDD and TDD.

<Inter-Band CA/DC and Intra-Band CA/DC>

The above-described CA may be implemented at a plurality of cells C of different frequency bands (Inter-band CA) or may be implemented at a plurality of cells C of the same frequency band (Intra-band CA). Moreover, the above-described DC may be implemented at a plurality of cells C respectively belonging to a plurality of cell groups of different frequency bands (Inter-band DC) or may be implemented at a plurality of cells C respectively belonging to a plurality of cell groups of the same frequency band (Intra-band DC).

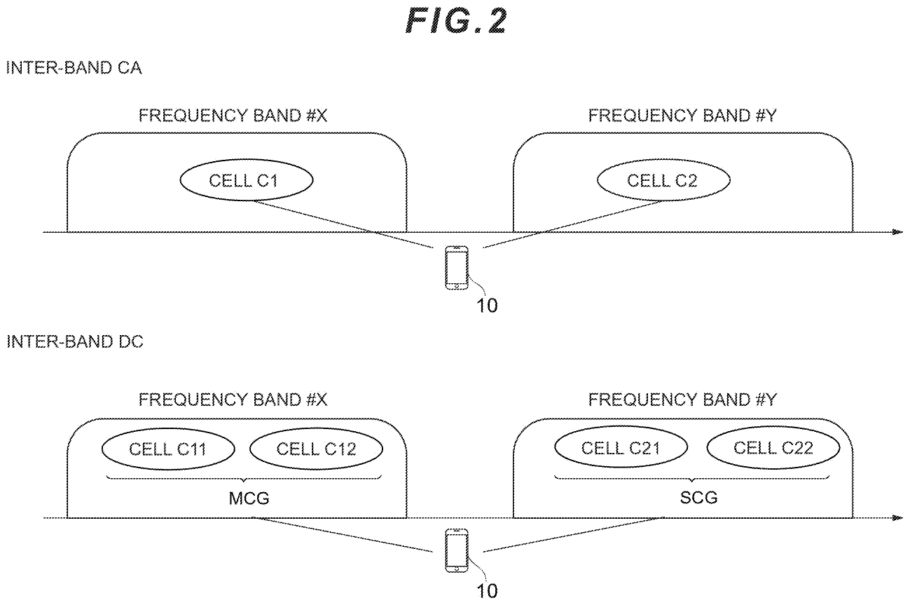

FIG. 2 is a diagram illustrating an example of the inter-band CA/DC according to this embodiment. Referring to FIG. 2, regarding the inter-band CA, the user terminal 10 may receive the downlink signal and/or transmit the uplink signal at a plurality of cells C1 and C2 belonging to different frequency bands #X and #Y.

Moreover, regarding the inter-band DC, the user terminal 10 may receive the downlink signal and/or transmit the uplink signal at MCG cells (cells C11 and C12 in this example) and SCG cells (cells C21 and C22 in this example) belonging to different frequency bands #X and #Y.

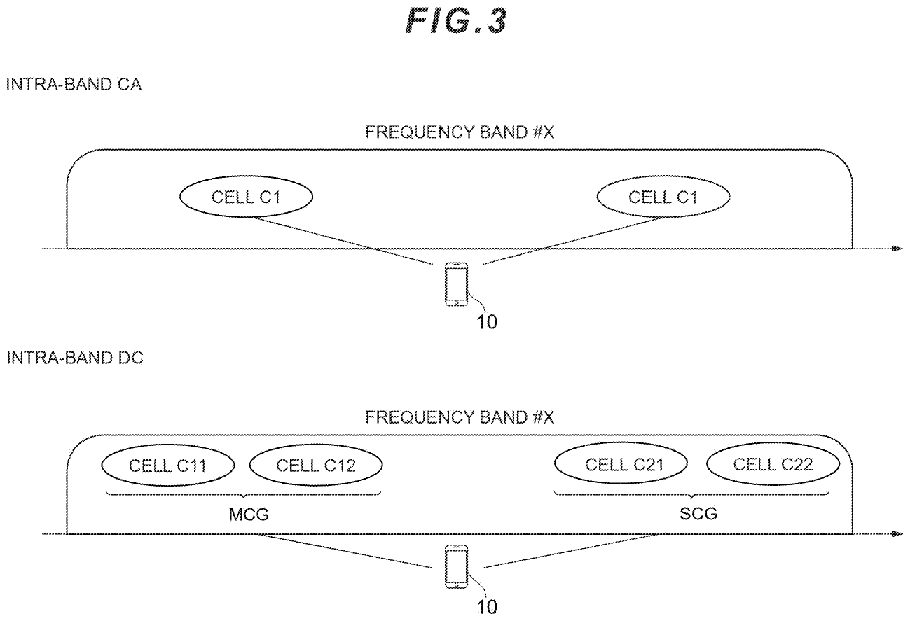

FIG. 3 is a diagram illustrating an example of the intra-band CA/DC according to this embodiment. Referring to FIG. 3, regarding the intra-band CA, the user terminal 10 may receive the downlink signal and/or transmit the uplink signal at the plurality of cells C1 and C2 belonging to the same frequency band #X. A plurality of carrier frequencies used respectively by the plurality of cells C1 and C2 may be continuous (Intra-band contiguous carrier aggregation) or non-continuous (Intra-band non-contiguous carrier aggregation).

Moreover, regarding the intra-band DC, the user terminal 10 may receive the downlink signal and/or transmit the uplink signal at MCG cells (cells C11 and C12 in this example) and SCG cells (cells C21 and C22 in this example) belonging to the same frequency band #X.

<Co-Located Scenario/Non-Co-Located Scenario

Regarding the above-described CA/DC, a co-located scenario where a plurality of transmission points (TP) corresponding to a plurality of cells C are co-located, and a non-co-located scenario where the plurality of TPs are not co-located are assumed. Incidentally, while Release 16 supports the co-located scenario and does not support the non-co-located scenario, making Release 17 and subsequent releases support both the co-located scenario and the non-co-located scenario is under discussion.

Under this circumstance, the plurality of TPs which are co-located are a plurality of transmission points which are geographically the same, and those plurality of TPs are located at the same position. On the other hand, the plurality of TPs which are not co-located are a plurality of TPS which are geographically different and those plurality of TPs are located at different positions. Incidentally, each TP is an apparatus which at least transmits the downlink signal to the user terminal 10 and may receive the uplink signal from the user terminal 10. Also, each TP may be a base station 20 or may be part of the base station 20 (such as a gNB-DU, an RRH, a DU, an antenna, or an antenna port).

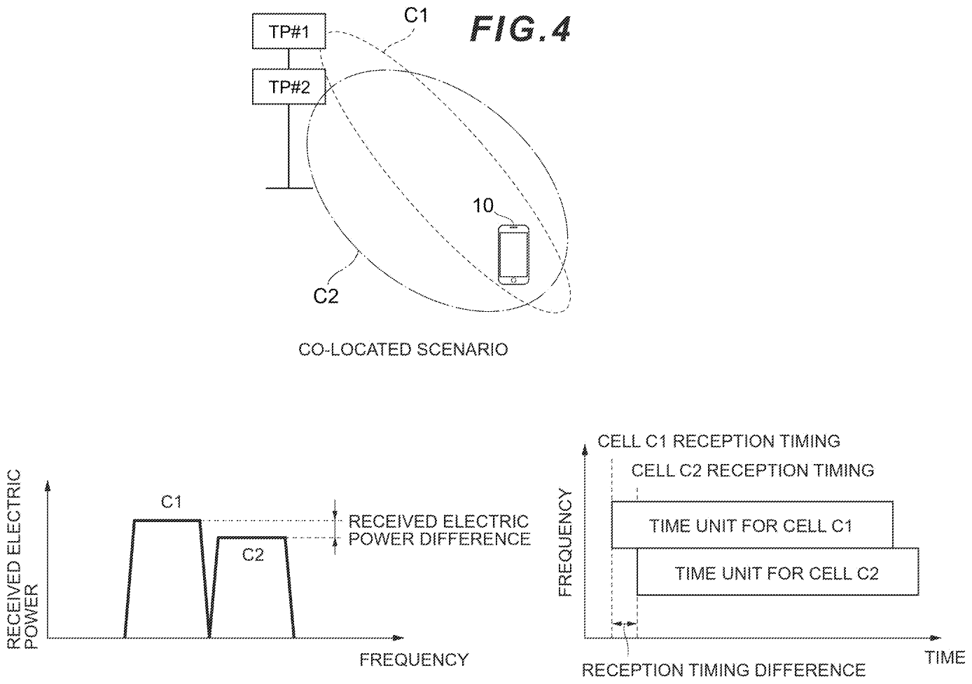

FIG. 4 is a diagram illustrating an example of the co-located scenario according to this embodiment. For example, referring to FIG. 4, the user terminal 10 receives the downlink signal from TP #1 and TP #2 respectively corresponding to the cells C1 and C2 by using the aforementioned CA/DC. Incidentally, in the case of the CA, one cell C1 or C2 may be a PCell and the other cell may be an SCell. Furthermore, in the case of the DC, one cell C1 or C2 may be an MCG cell and the other cell may be an SCG cell.

In the co-located scenario as illustrated in FIG. 4, TP #1 which forms the cell C1 and TP #2 which forms the cell C2 are located at the same position. TP #1 and TP #2 may transmit the downlink signal by using different antenna patterns as illustrated in FIG. 4. Incidentally, needless to say, TP #1 and TP #2 may use the same antenna pattern (including non-directivity).

In the co-located scenario, TP #1 and TP #2 respectively transmit the downlink signal at the cells (carriers) C1 and C2 corresponding to TP #1 and TP #2 with the same transmission electric power and/or at the same timing. On the other hand, for example, the user terminal 10 can receive the downlink signal from TP #1 and TP #2 at different electric power levels and/or timings due to various factors such as an antenna pattern difference or a synchronization error between TP #1 and TP #2, and the status of a propagation path between TP #1 and TP #2 and the user terminal 10.

For example, referring to FIG. 4, the received electric power of the downlink signal at the cell C1 is larger than the received electric power of the downlink signal at the cell C2. On the other hand, TP #1 and TP #2 corresponding to the cells C1 and C2 are located at the same position in the co-located scenario, so that the difference in the received electric power of the downlink signal between the cells C1 and C2 (hereinafter referred to as the “received electric power difference”) becomes relatively small. The above-mentioned received electric power difference may be also restated as “power imbalance.”

Furthermore, in the co-located scenario, the difference in the reception timings between the cells C1 and C2 (hereinafter referred to as the “reception timing difference”) becomes relatively small. Incidentally, in the co-located scenario, the above-mentioned reception timing difference is, for example, approximately several μs, which is sufficiently smaller than a specified time unit (for example, a subframe (1 ms) or a slot (e.g., approximately tens of microseconds to 1 ms)).

Under this circumstance, the reception timing difference between the cells C1 and C2 may be the difference in the downlink signal reception timings between the cells C1 and C2 or may be the difference in the time unit reception timings between the cell C1 and the cell C2. The above-mentioned time unit is, for example, a subframe and/or a slot. For example, in the case of the EN-DC or the NE-DC, the time unit of one cell C may be a subframe and the time unit for the other cell C may be a slot. Moreover, for example, in the case of the NR-DC and the CA, time slots for both the cell C1 and the cell C2 may be slots. The reception timing difference of such time units may be a relative timing difference between a boundary for the time unit for the cell C1 and a boundary for the time unit for the cell C2 which is closest to the time unit for the cell C1 (closest time unit). Moreover, the boundary for the time unit may be, for example, the timing to start the time unit.

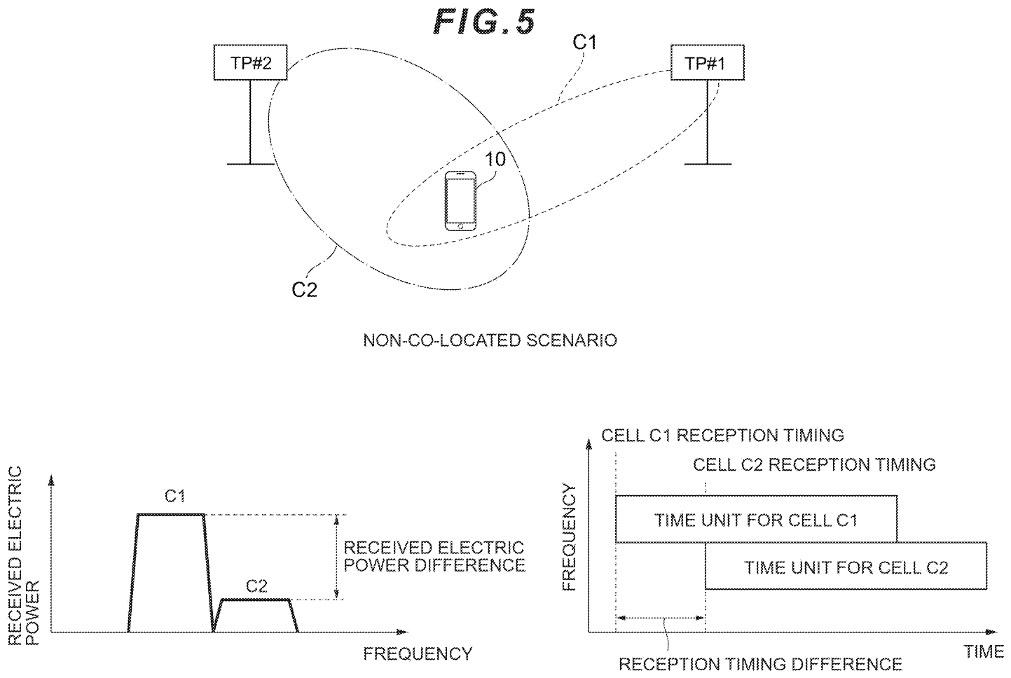

FIG. 5 is a diagram illustrating an example of the non-co-located scenario according to this embodiment. The non-co-located scenario illustrated in FIG. 5 is different from the co-located scenario illustrated in FIG. 4 in that TP #1 which forms the cell C1 and TP #2 which forms the cell C2 are located at different positions in the non-co-located scenario. FIG. 5 will mainly explain the difference from FIG. 4.

Since TP #1 and TP #2 corresponding to the cells C1 and C2 are located at different positions in the non-co-located scenario as illustrated in FIG. 5, it is assumed that the received electric power difference between the cells C1 and C2 becomes larger than that in the co-located scenario. Furthermore, in the non-co-located scenario, it is assumed that the reception timing difference between the cells C1 and C2 becomes larger than that in the co-located scenario.

<Required Conditions>

It is specified regarding the radio communication system 1 that when specified required conditions (requirements) are satisfied, it is necessary for the user terminal 10 to deliver specified performance. Regarding the CA/DA in the non-co-located scenario as described earlier, it is assumed that the received electric power difference and/or the reception timing difference between the plurality of cells C will become larger than that/those of the CA/DC in the co-located scenario. Therefore, it is assumed that the required conditions for the user terminal 10 to deliver the specified performance may vary between the co-located scenario and the non-co-located scenario.

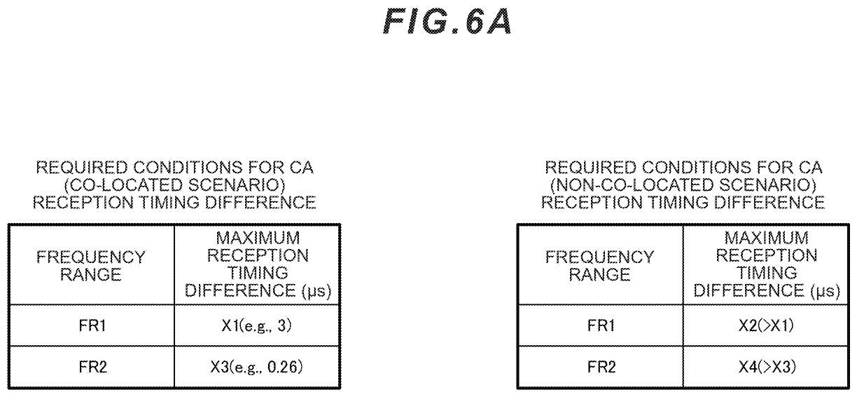

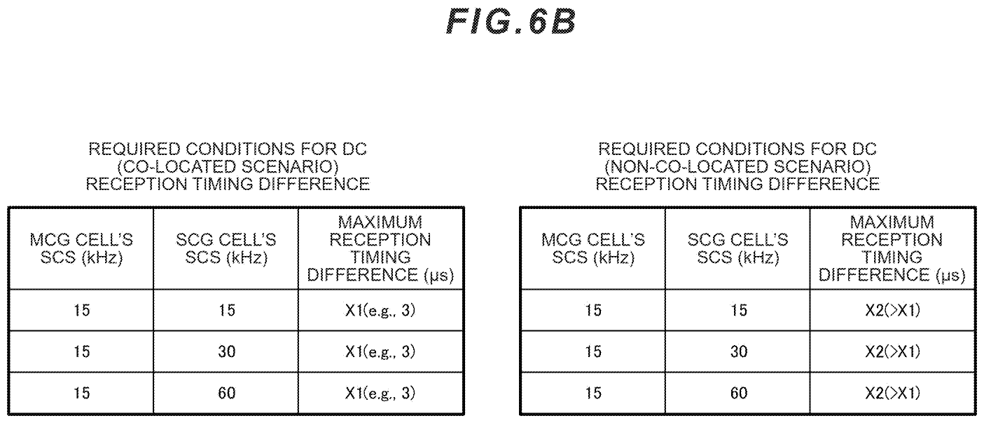

FIG. 6A and FIG. 6B are diagrams illustrating an example of the required conditions for the reception timing difference in the CA and the DC according to this embodiment. In the case of the CA as illustrated in FIG. 6A, the maximum value of the reception timing difference between the cells C (hereinafter also referred to as the “maximum reception timing difference”) may be set for each frequency range (FR). For example, in the case of the CA in the co-located scenario, the maximum reception timing difference between the cells C may be a specified value X1 (such as 3 μs) in a case of FR1 and may be a specified value X3 (such as 0.26) in a case of FR2. Since FR2 is a higher frequency band than FR1, the maximum reception timing difference X3 of FR2 may be smaller than the maximum reception timing difference X1 of FR1.

On the other hand, in the case of the CA in the non-co-located scenario, the maximum reception timing difference between the cells C may be a specified value X2 which is larger than the above-mentioned specified value X1, or may be a specified value X4 which is larger than the above-mentioned specified value X3. Regarding the CA in the non-co-located scenario as well, the maximum reception timing difference may be set for each FR.

In the case of the DC as illustrated in FIG. 6B, the maximum reception timing difference may be associated with a subcarrier spacing (SubCarrier Spacing: SCS) of an MCG cell and the SCS of an SCG cell. For example, in the case of the DC in the co-located scenario (such as EN-DC), the maximum reception timing difference between the MCG cell and the SCG cell may be the specified value X1 (such as 3 μs). On the other hand, in the case of the DC in the non-co-located scenario (such as EN-DC), the maximum reception timing difference between the MCG cell and the SCG cell may be the specified value X2 which is larger than the above-mentioned specified value X1.

Incidentally, referring to FIG. 6B, the same value X1 or value X2 is specified as the maximum reception timing difference, irrespective of the MCG cell's SCS or the SCG cell's SCS; however, there is no limitation to this example. The maximum reception timing difference may vary according to a combination of the MCG cell's SCS and the SCG cell's SCS. Moreover, in FIG. 6A and FIG. 6B, the same maximum reception timing difference X1 or X2 is set for both the DC and the CA (such as CA of FR1); however, different maximum reception timing differences may be used for the DC and the CA. Furthermore, in the case of the DC, the maximum reception timing difference may be set based on the FR of the MCG cell and/or the SCG cell.

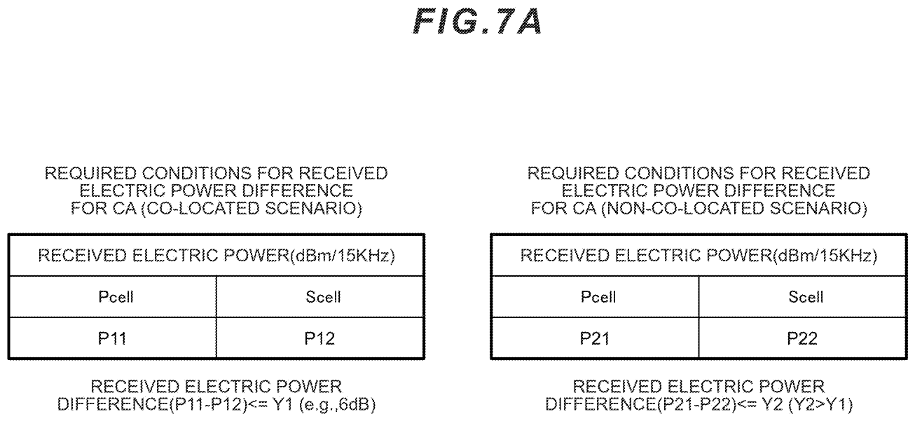

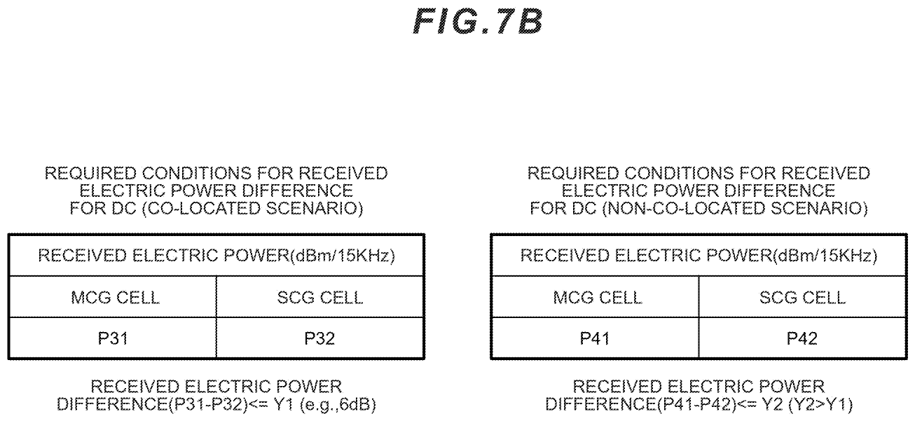

FIG. 7A and FIG. 7B are diagrams illustrating an example of required conditions for the received electric power difference of the CA and the DC according to this embodiment. For example, in the case of the CA in the co-located scenario as illustrated in FIG. 7A, received electric power values P11 and P12 of a PCell and an SCell may be set to deliver specified performance (such as specified throughput at a specified cell) under specified conditions (such as at least one of a specified bandwidth, a specified reference channel, a specified subcarrier spacing, and a specified FR). Under this circumstance, the received electric power values P11 and P12 may be set so that the received electric power difference between the received electric power values P11 and P12 becomes equal to or less than a specified value Y1 (such as 6 dB) (or less).

On the other hand, in the case of the CA in the non-co-located scenario, received electric power values P21 and P22 of a PCell and an SCell may be set to deliver the above-described specified performance under the above-described specified conditions. Under this circumstance, the received electric power values P21 and P22 may be set so that the received electric power difference between the received electric power values P21 and P22 becomes equal to or less than a specified value Y2 (or less). The above-mentioned specified value Y2 may be a value larger than the specified value Y1 used for the CA in the co-located scenario.

In the case of the DC in the co-located scenario as illustrated in FIG. 7B, received electric power values P31 and P32 of an MCG cell and an SCG to satisfy the above-mentioned specified performance under the above-mentioned specified conditions may be set. Under this circumstance, the received electric power values P31 and P32 may be set so that the received electric power difference between the received electric power values P31 and P32 becomes equal to or less than the specified value Y1 (such as 6 dB) (or less).

On the other hand, in the case of the DC in the non-co-located scenario, received electric power values P41 and P42 of an MCG cell and an SCG may be set to deliver the above-mentioned specified performance under the above-mentioned specified conditions. Under this circumstance, the received electric power values P41 and P42 may be set so that the received electric power difference between the received electric power values P41 and P42 becomes equal to or less than the specified value Y2 (or less). The above-mentioned specified value Y2 may be a value larger than the specified value Y1 used for the CA in the co-located scenario.

Incidentally, in FIGS. 7A and 7B, the respective received electric power values of the plurality of cells are set as the required conditions so that the received electric power difference between the plurality of cells becomes smaller than the maximum value of the received electric power difference (hereinafter referred to as the “maximum received electric power difference”) (such as the specified value Y1 or Y2); however, there is no limitation to this example. The maximum received electric power difference (such as the specified value Y1 or Y2) which delivers the specified performance under the specified conditions may be set like the maximum reception timing difference (such as the specified value X1 or X2) as illustrated in FIG. 6A and FIG. 6B. Moreover, the above-mentioned maximum received electric power difference may be set based on at least one of the bandwidth, reference channel, subcarrier spacing, and FR of each of the plurality of cells.

As stated above, the required conditions to deliver the specified performance for the CA/DC are set for each scenario. The user terminal 10 does not necessarily support the required conditions for both the co-located scenario and the non-co-located scenario, and it is also assumed that the user terminal 10 may support only the required conditions for either one of the co-located scenario or the non-co-located scenario.

However, since the base station 20 cannot recognize which scenario the user terminal 10 supports, there is the risk that the base station 20 may permit a user terminal 10 which does not support the non-co-located scenario to implement the CA/DC in the non-co-located scenario. In this case, there is the risk that the user terminal may fail to deliver the specified performance as a result of an attempt to implement the CA/DC in the non-co-located scenario on the basis of the required conditions for the co-located scenario where the reception timing difference and/or the received electric power difference between the cells are/is shorter than those/that of the co-located scenario.

Accordingly, in this embodiment, the user terminal 10 notifies the base station 20 of information about support for the required conditions for the case where the plurality of TPs corresponding to the plurality of cells C are not co-located in the CA/DC (i.e., the non-co-located scenario) (hereinafter referred to as the “support information”), so that the base station 20 thereby allows, on the basis of the support information, only a user terminal 10 which supports the non-co-located scenario to implement the CA/DC in the non-co-located scenario.

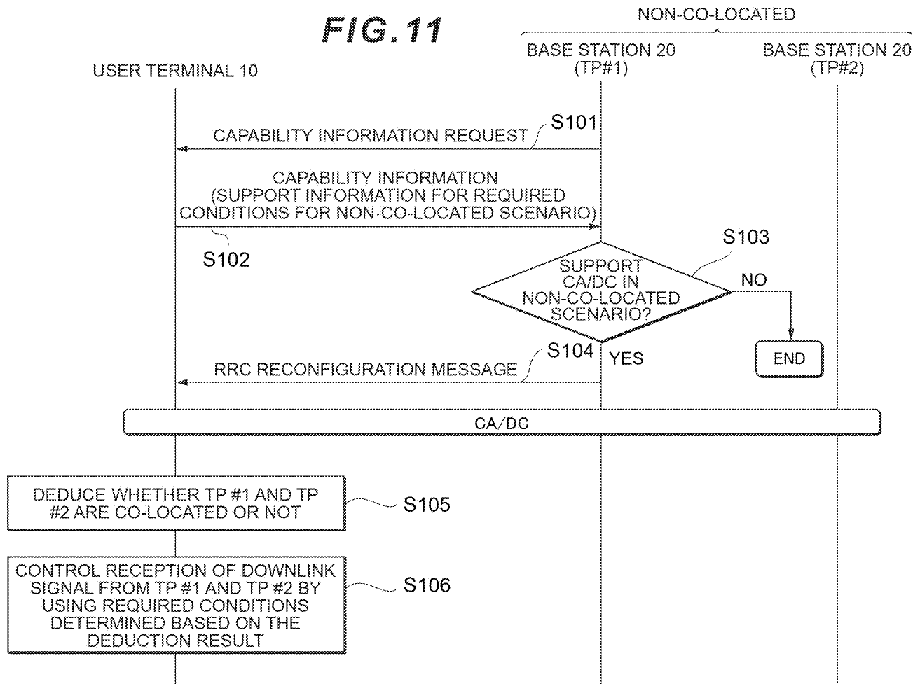

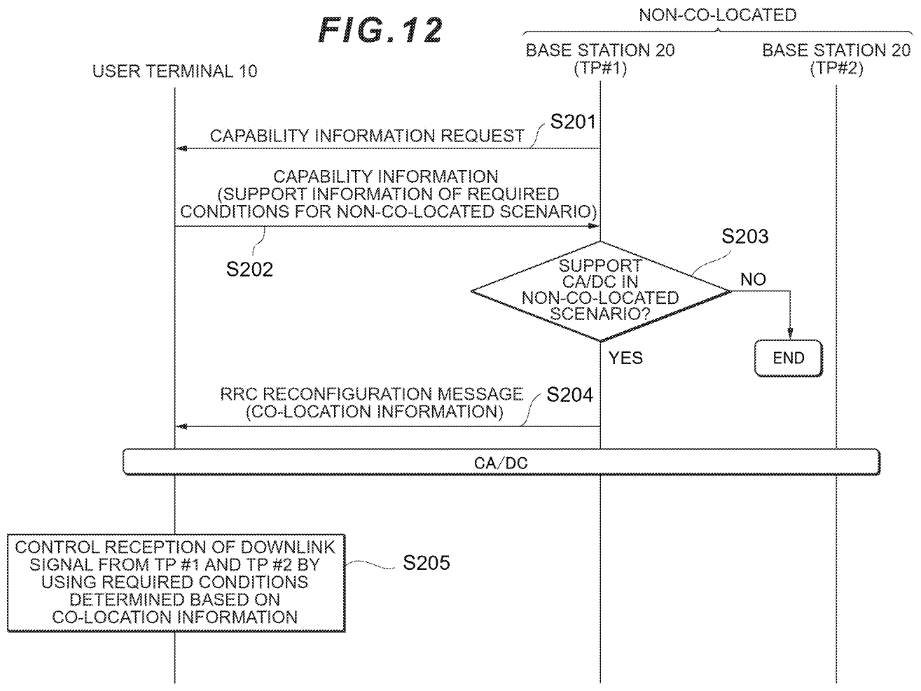

Furthermore, in this embodiment, the user terminal 10 receives the downlink signal from the plurality of TPs respectively corresponding to the plurality of cells C by using the CA/DC, The user terminal 10 controls the reception of the downlink signal on the basis of whether the relevant plurality of TPs are co-located or not. As a result, the downlink signal can be received appropriately under the required conditions for the scenario of the CA/DC which is configured for the user terminal 10. Whether the plurality of TPs are co-located or not may be deduced by the user terminal 10 (for example, FIG. 11) or may be reported by the base station 20 (for example, FIG. 12).

(Detailed Configuration of Radio Communication System)

Next, the detailed configuration of each apparatus of the above-described radio communication system 1 will be explained, Incidentally, the following configurations are intended to show necessary configurations for the explanation of this embodiment and do not exclude the case where each apparatus may include any functional block(s) other than those illustrated in the relevant drawing(s).

<Hardware Configuration>

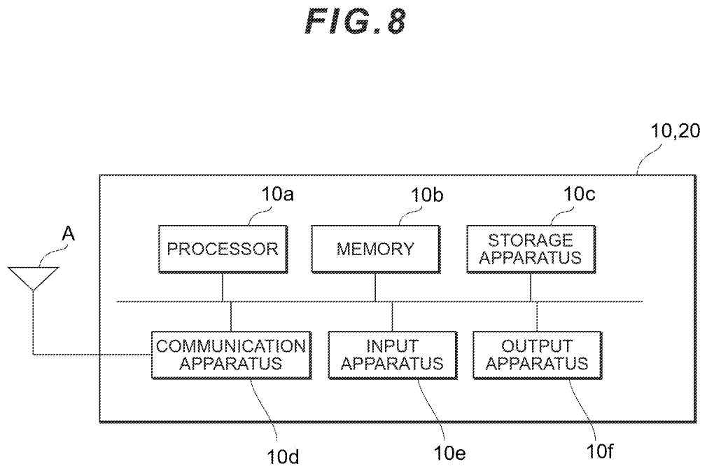

FIG. 8 is a diagram illustrating an example of a hardware configuration of each apparatus in the radio communication system according to this embodiment. Each apparatus (such as each of the user terminal(s) 10 and the base station(s) 20) in the radio communication system 1 has at least a processor 10a, a memory 10b, a storage apparatus 10c, a communication apparatus 10d which performs wired or radio communication, an input apparatus 10e which accepts input operations, an output apparatus 10f which outputs information, and one or more antennas A.

The processor 10a is, for example, a CPU (Central Processing Unit) and controls each apparatus in the radio communication system 1. The processor 10a may configure a control unit for controlling each apparatus.

The memory 10b is configured of, for example, a ROM(s) (Read Only Memory/Memories), an EPROM(s) (Erasable Programmable ROM(s)), an EEPROM(s) (Electrically Erasable Programmable ROM(s)), and/or a RAM(s) (Random Access Memory/Memories).

The storage apparatus 10c is configured of, for example, storage units such as an HDD(s) (Hard Disk Drive(s)), an SSD(s) (Solid State Drive(s)), and/or an eMMC(s) (embedded Multi Media Card(s)).

The communication apparatus 10d is an apparatus which performs communication via a wired and/or radio network and is, for example, a network card or a communication module. Moreover, the communication apparatus 10d may include an amplifier, an RF (Radio Frequency) apparatus which performs processing regarding a radio signal, and a BB (Base Band) apparatus which performs base band signal processing.

The RF apparatus generates a radio signal to be transmitted from the antenna A by, for example, performing D/A conversion, modulation, frequency conversion, power amplification, and so on with respect to a digital base band signal received from the BB apparatus. Furthermore, the RF apparatus generates the digital base band signal by performing frequency conversion, demodulation, ND conversion, and so on with respect to the radio signal received from the antenna A and transmits the digital base band signal to the BB apparatus. The BB apparatus performs processing for converting the digital base band signal into an IP packet(s) and processing for converting the IP packet(s) into the digital base band signal.

The input apparatus 10e is, for example, a keyboard, a touch panel, a mouse, and/or microphone. The output apparatus 10f is, for example, a display and/or a speaker.

<Functional Block Configuration>

<<The User Terminal>>

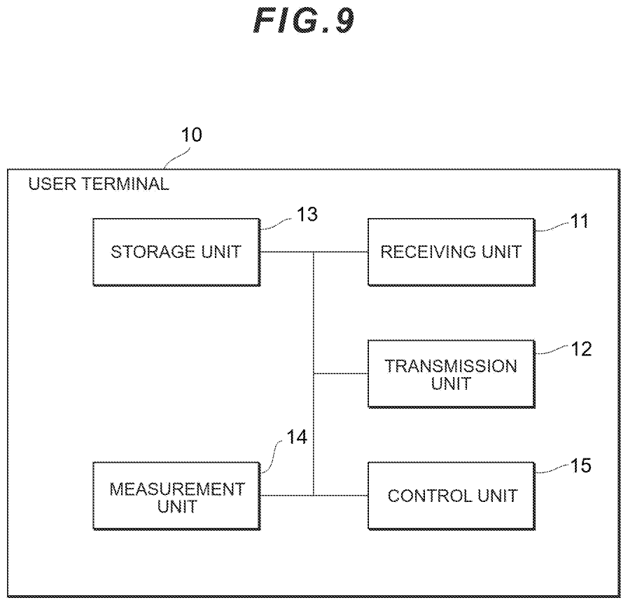

FIG. 9 is a diagram illustrating an example of a functional block configuration of a user terminal according to this embodiment. Referring to FIG. 9, a user terminal 10 includes a receiving unit 11, a transmission unit 12, a storage unit 13, a measurement unit 14, and a control unit 15.

The receiving unit 11 receives a downlink signal. The downlink signal may be, for example, at least one of a broadcast channel (a physical broadcast channel (Physical Broadcast Channel: PBCH)), a synchronization signal (Synchronization Signal: SS), a downlink shared channel (a physical downlink shared channel (Physical Downlink Shared Channel: PDSCH)), a downlink control channel (a physical downlink control channel (Physical Downlink Control Channel: PDCCH)), a downlink reference signal, and so on.

The synchronization signal may include a primary synchronization signal (Primary Synchronization Signal: PSS) and/or a secondary synchronization signal (Secondary Synchronization Signal: PSS). A block(s) including the synchronization signal and PBCH may be called an SS/PBCH block(s) or a synchronization signal block(s) (SSB). The downlink reference signal may include, for example, at least one of a demodulation reference signal (Demodulation Reference Signal: DMRS), a channel state information reference signal (Channel State Information Reference Signal: CSI-RS)), etc., of the PDCCH and/or the PDSCH.

Furthermore, the receiving unit 11 may perform processing (such as reception, de-mapping, demodulation, and decoding) regarding the reception of information and/or data transmitted via the downlink signal. Specifically, the receiving unit 11 receives information requesting capability information of the user terminal 10 (hereinafter referred to as the “capability information request”). The capability information request is transmitted from the base station 20 to the user terminal 10 by means of upper-layer signaling and may be, for example, an RRC message “UE Capability Enquiry.”

Moreover, the receiving unit 11 receives an RRC reconfiguration message including CA/DC configuration information (such as an RRC message “RRC Reconfiguration”). Furthermore, the receiving unit 11 receives the downlink signal from a plurality of TPs respectively corresponding to a plurality of cells C by using the CA/DC.

Furthermore, the receiving unit 11 may receive information about whether the plurality of TPs respectively corresponding to the plurality of cells C are co-located or not (hereinafter referred to as the “co-location information”) from the base station 20 (for example, FIG. 12). The co-location information may be included in, for example, the RRC message “RRC Reconfiguration.” The RRC message may relate to an addition of an SCell in the CA or an addition of a cell group or an SCell in the DC.

The transmission unit 12 transmits an uplink signal. The uplink signal may be, for example, at least one of a random access channel (a physical random access channel (Physical Random Access Channel: PRACH), an uplink control channel (a physical uplink control channel (Physical Uplink Control Channel: PUCCH)), an uplink shared channel (a physical uplink shared channel (Physical Uplink Shared Channel: PUSCH)), and an uplink reference signal. The uplink reference signal may include, for example, at least one of a DMRS, a sounding reference signal (Sounding Reference Signal: SRS), etc., of the PUCCH and/or the PUSCH.

Furthermore, the transmission unit 12 may perform processing (such as reception, de-mapping, demodulation, and decoding) regarding the reception of information and/or data transmitted via the uplink signal. Specifically, the transmission unit 12 receives the capability information of the user terminal 10. The capability information is information about capabilities of the user terminal 10 and may include information indicating whether or not the user terminal 10 supports various kinds of required conditions and/or functions. Furthermore, the capability information is transmitted from the user terminal 10 to the base station 20 by means of upper-layer signaling and may be, for example, “UE Capability Information” of the RRC IE.

More specifically, the transmission unit 12 transmits the support information for the required conditions when the plurality of TPs are not co-located (i.e., the non-co-located scenario). The support information may be included in the aforementioned capability information. The support information for the required conditions for the non-co-located scenario may indicate support or lack thereof for the non-co-located scenario, or may indicate support or lack thereof for the required conditions for the non-co-located scenario.

The required conditions for the non-co-located scenario may relate to the reception timing difference between the plurality of cells C for which the CA/DC is implemented, and/or may relate to the received electric power difference between the plurality of cells C. Therefore, the support information for the required conditions for the non-co-located scenario may be restated as the “support information for the required conditions regarding the relevant reception timing difference” and/or the “support information for the required conditions regarding the relevant received electric power difference.”

For example, as illustrated in FIGS. 6A and 6B, the maximum reception timing difference X2 or X4 in the non-co-located scenario is larger than the maximum reception timing difference X1 or X3 when the plurality of TPs are co-located (i.e., the co-located scenario). The support information for the required conditions regarding the aforementioned reception timing difference may indicate whether or not to support the maximum reception timing difference X1 or X3 which is longer than the maximum reception timing difference X1 or X3 (i.e., a longer reception time difference).

Furthermore, for example, as illustrated in FIGS. 7A and 7B, the maximum received electric power difference Y2 in the non-co-located scenario is larger than the maximum received electric power difference Y1 in the co-located scenario. The support information for the required conditions regarding the aforementioned received electric power difference may indicate whether or not to support the maximum received electric power difference Y2 which is larger than the maximum received electric power difference Y1 (i.e., larger received electric power difference or larger power imbalance).

The storage unit 13 stores various required conditions to satisfy the specified performance. Specifically, the storage unit 13 may store the required conditions for the non-co-located scenario and the required conditions for the co-located scenario.

The required conditions for the co-located scenario as described earlier may include one of the required conditions regarding the reception timing difference between the cells in the case of the CA (such as the left table in FIG. 6A), the required conditions regarding the received electric power difference between the cells in the case of the CA (such as the left table in FIG. 7A), the required conditions regarding the reception timing difference between the cells in the case of the DC (such as the left table in FIG. 6B), and the required conditions regarding the received electric power difference between the cells in the case of the DC (such as the left table in FIG. 7B).

Furthermore, the required conditions for the non-co-located scenario may include at least one of the required conditions regarding the reception timing difference between the cells in the case of the CA (such as the right table in FIG. 6A), the required conditions regarding the received electric power difference between the cells in the case of the CA (such as the right table in FIG. 7A), the required conditions regarding the reception timing difference between the cells in the case of the DC (such as the right table in FIG. 6B), and the required conditions regarding the received electric power difference between the cells in the case of the DC (such as the right table in FIG. 7B).

The measurement unit 14 measures the received electric power and/or the reception timing of the downlink signal at the plurality of cells C. The received electric power may be, for example, Reference Signal Received Power (RSRP), Synchronization Signal based Reference Signal Received Power (SS-RSRP) (which is also called SS/PBCH block RSRP), or CSI-RS based Reference Signal Received Power (CSI-RS-RSRP). The reception timing may be, for example, the timing to start the relevant time unit (such as a subframe or a slot) for each cell.

The control unit 15 performs various kinds of control at the user terminal 10. Specifically, the control unit 15 controls the reception of the downlink signal from the plurality of TPs corresponding to the plurality of cells C by using the CA/DC. For example, the control unit 15 may control the reception of the downlink signal from the plurality of TPs on the basis of either the required conditions for the non-co-located scenario (such as the right diagram in FIG. 6A, 6B, 7A, or 7B) or the required conditions for the co-located scenario (such as the left diagram in FIG. 6A, 6B, 7A, or 7B).

Furthermore, the control unit 15 may estimate whether the aforementioned plurality of TPs are co-located or not, and control the reception of the downlink signal from the plurality of TPs on the basis of the result of the estimation (e.g., FIG. 11). Specifically, the control unit 15 may estimate whether the plurality of TPs are co-located or not, on the basis of the received electric power difference and/or the reception timing difference between the plurality of cells C.

For example, if the received electric power difference between the plurality of cells C, which is measured by the measurement unit 14, is equal to or smaller than a specified threshold value (or less), the control unit 15 may estimate that the plurality of TPs corresponding to the relevant plurality of cells C are co-located, and may control the reception of the downlink signal from the plurality of TPs on the basis of the required conditions for the co-located scenario.

On the other hand, if the received electric power difference between the relevant plurality of cells C is larger than a specified threshold value (or more), the control unit 15 may estimate that the plurality of TPs corresponding to the relevant plurality of cells C are not co-located, and may control the reception of the downlink signal from the relevant plurality of TPs on the basis of the required conditions for the non-co-located scenario.

Alternatively, the control unit 15 may control the reception of the downlink signal from the aforementioned plurality of TPs on the basis of the co-location information reported from the base station 20 (e.g., FIG. 12). For example, if the co-location information indicates that the aforementioned plurality of TPs are co-located, the control unit 15 may control the reception of the downlink signal from the relevant plurality of TPs on the basis of the required conditions for the co-located scenario. On the other hand, if the co-location information indicates that the aforementioned plurality of TPs are not co-located, the control unit 15 may control the reception of the downlink signal from the relevant plurality of TPs on the basis of the required conditions for the non-co-located scenario.

Incidentally, the storage unit 13 may be implemented by, for example, the storage apparatus 10c. The receiving unit 11, the transmission unit 12, and the measurement unit 14 may be implemented by, for example, the communication apparatus 10d or may be implemented by the processor 10a, in addition to the communication apparatus 10d, by executing a program(s) stored in the storage apparatus 10c. The control unit 15 may be implemented by the processor 10a by executing the program(s) stored in the storage apparatus 10c. When executing the program, the relevant program may be stored in a storage medium. The storage medium in which the relevant program is stored may be a non-transitory computer-readable medium. There is no particular limitation to the non-transitory storage medium, and it may be, for example, a storage medium such as a USB (Universal Serial Bus) memory or a CD-ROM (Compact Disc ROM),

<<Base Station>>

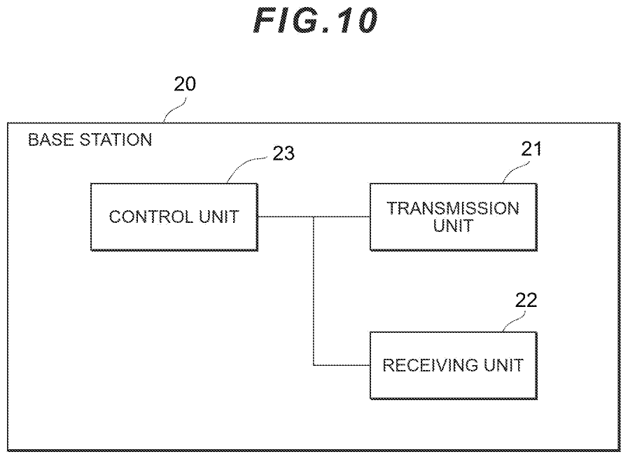

FIG. 10 is a diagram illustrating an example of a functional block configuration of a base station according to this embodiment. The base station 20 includes a transmission unit 21, a receiving unit 22, and a control unit 23 as illustrated in FIG. 10.

The transmission unit 21 transmits the downlink signal. Moreover, the transmission unit 21 performs processing (such as encoding, decoding, and mapping to a resource) regarding information and/or data transmitted via the relevant downlink signal. Specifically, the transmission unit 21 may transmit at least one of the aforementioned capability information request, the co-location information, and the RRC reconfiguration message.

The receiving unit 22 receives the uplink signal. Moreover, the receiving unit 22 performs processing (such as de-mapping, demodulation, and decoding) regarding information and/or data transmitted via the relevant uplink signal. Specifically, the receiving unit 22 may receive at least one of the aforementioned capability information and the support information for the required conditions for the non-co-located scenario.

The control unit 23 performs various kinds of control regarding the communication between the user terminal 10 and the base station 20. Specifically, the control unit 23 controls the transmission of the downlink signal by the transmission unit 21 and/or the reception of the uplink signal by the receiving unit 22. The control unit 23 may control the CA/DC on the basis of the capability information from the user terminal 10.

For example, if the aforementioned support information indicates that the required conditions for the non-co-located scenario are supported, the control unit 23 may configure the user terminal 10 for CA/DC with TPs which are not co-located with the base station 20 (i.e., the CA/DC in the non-co-located scenario).

On the other hand, if the aforementioned support information indicates that the required conditions for the non-co-located scenario are not supported, the control unit 23 may not configure the user terminal 10 for CA/DC with TPs which are not co-located with the base station 20 (i.e., the CA/DC in the non-co-located scenario). In this case, the control unit 23 may configure the user terminal 10 for CA/DC with TPs which are co-located with the base station 20 (i.e., the CA/DC in the co-located scenario).

Incidentally, the transmission unit 21 and the receiving unit 22 may be implemented by, for example, the communication apparatus 10d or may be implemented by the processor 10a, in addition to the communication apparatus 10d, by executing a program(s) stored in the storage apparatus 10c. The control unit 23 may be implemented by the processor 10a by executing the program(s) stored in the storage apparatus 10c.

(Operations of Radio Communication System)

Next, an explanation will be provided about operations of the radio communication system 1 which is configured as described above. Incidentally, FIG. 11 and FIG. 12 are just illustrations of examples and it goes without saying that some step(s) may be omitted and/or any step not indicated in the drawing(s) may also be implemented.

FIG. 11 is a diagram illustrating an example of a first operation regarding the CA/DC according to this embodiment. For example, in FIG. 11, the case where TP #1 and TP #2 are not co-located is assumed. Base stations 20 corresponding to TP #1 and TP #2 may be the same or different. Moreover, for example, in FIG. 11, the user terminal 10 communicates at an SpCell (TP #1) and a case of adding an SCell (TP #2) or an SCG cell (TP #2) is assumed.

Referring to FIG. 11, in step S101, the base station 20 transmits a capability information request (such as an RRC message “UE Capability Enquiry”) to the user terminal 10. In step S102, the user terminal 10 transmits the capability information including the support information for the required conditions for the non-co-located scenario (such as RRC IE “UE Capability Information”) in response to the capability information request from the base station 20.

In step S103, the base station 20 judges whether the user terminal 10 supports the CA/DC in the non-co-located scenario or not, based on the support information from the user terminal 10. If the CA/DC in the non-co-located scenario is supported (step S103: Yes), the base station 20 configures the user terminal 10 for CA/DC in the non-co-located scenario in step S104. Specifically, the base station 20 may transmit an RRC reconfiguration message including configuration information for the CA/DC (such as an RRC message “RRC Reconfiguration”) to the user terminal 10. The user terminal 10 starts the CA/DC at the cells C corresponding to TP #1 and TP #2, respectively, on the basis of the relevant RRC reconfiguration message. If the CA/DC in the non-co-located scenario is not supported (step S103: No), this operation terminates.

In step S105, the user terminal 10 deduces whether TP #1 and TP #2 are co-located or not. For example, the user terminal 10 deduces whether TP #1 and TP #2 are co-located or not, on the basis of the received electric power difference and/or the reception timing difference of the downlink signal (such as the downlink reference signal or the synchronization signal) from TP #1 and TP #2.

In step S106, the user terminal 10 configures the CA/DC on the basis of the RRC reconfiguration message received in step S104. Furthermore, the user terminal 10 controls the reception of the downlink signal from TP #1 and TP #2 by using the required conditions decided based on the deduction result in step S105. Under this circumstance, it is deduced that TP #1 and TP #2 are not co-located, so the user terminal 10 decides to use the required conditions for the non-co-located scenario (e.g., the right diagram in FIG. 6A, 6B, 7A, or 7B).

According to the aforementioned first operation, whether the plurality of TPs are co-located or not is deduced by the user terminal 10, so that the base station 20 does not have to notify the user terminal 10 of the co-location information regarding whether the relevant plurality of TPs are co-located or not. Therefore, it is possible to control the CA/DC in the non-co-located scenario appropriately while preventing an increase in overheads between the user terminal 10 and the base station 20.

FIG. 12 is a diagram illustrating an example of a second operation regarding the CA/DC according to this embodiment. FIG. 12 assumes a case similar to that of FIG. 11, and so will mainly explain the difference from FIG. 11, Steps 3201 to S203 in FIG. 12 are similar to steps S101 to S103 in FIG. 11.

In step S204 in FIG. 12, the base station 20 includes the co-location information, which indicates that TP #1 and TP #2 are not co-located, in an RRC reconfiguration message (such as an RRC message “RRC Reconfiguration”) and transmits it to the user terminal 10.

In step S205, the user terminal 10 configures the CA/DC on the basis of the RRC reconfiguration message received in step S204. Furthermore, the user terminal 10 controls the reception of the downlink signal from TP #1 and TP #2 by using the required conditions decided on the basis of the co-location information in the relevant RRC reconfiguration message, Under this circumstance, the co-location information indicates that TP #1 and TP #2 are not co-located, so the user terminal 10 decides to use the required conditions for the non-co-located scenario (e.g., the right diagram in FIG. 6A, 6B, 7A, or 7B).

According to the aforementioned second operation, whether the plurality of TPs are co-located or not is reported by the base station 20 to the user terminal 10, so the user terminal 10 can control the reception of the downlink signal in the case of the CA/DC in the non-co-located scenario appropriately in accordance with the required conditions for the non-co-located scenario.

If the radio communication system 1 according to this embodiment is employed as described above when the CA/DC in the non-co-located scenario is introduced, the user terminal 10 can appropriately control the reception of the downlink signal in the case of the CA/DC in the non-co-located scenario in accordance with the required conditions in the non-co-located scenario.

### OTHER EMBODIMENTS

The upper-layer signaling in the aforementioned embodiment may be signaling of an upper-layer higher than Layer 1, such as RRC signaling or MAC signaling. Moreover, the co-located scenario may be also called, for example, a first scenario (or a second scenario). Meanwhile, the non-co-located scenario may be also called, for example, a second scenario (or a first scenario), Furthermore, the required conditions for each parameter of the co-located scenario (such as the reception timing difference and the received electric power difference) may be also called, for example, a first required condition (or a second required condition) of each relevant parameter. Meanwhile, the required conditions for each parameter of the non-co-located scenario (such as the reception timing difference and the received electric power difference) may be also called, for example, a second required condition (or a first required condition) of each relevant parameter. Furthermore, the tables for the co-located scenario on the left side of FIGS. 6A, 6B, 7A, and 7B may be also called, for example, first tables (or second tables). Furthermore, the tables for the non-co-located scenario on the right side of FIGS. 6A, 6B, 7A, and 7B may be also called, for example, second tables (or first tables).

The above-explained embodiment is designed to make it easy to understand the present invention, but is not intended to interpret the present invention in a limited manner. The flowcharts, sequences, and respective elements included in the embodiment and their arrangement, materials, conditions, shapes, sizes, and so on which have been explained in the embodiment are not limited to those illustrated as examples, but can be changed as appropriate. Furthermore, it is possible to partially replace or combine configurations indicated in different embodiments.

### REFERENCE SIGNS LIST

1 radio communication system
11 receiving unit
12 transmission unit
13 storage unit
14 measurement unit
15 control unit
20 base station
21 transmission unit
22 receiving unit
23 control unit
30 core network
A antenna
10a processor
10b memory
10c storage apparatus
10d communication apparatus
10e input apparatus
10f output apparatus

1. A user terminal comprising:
a receiving unit that receives a downlink signal from a plurality of transmission points respectively corresponding to a plurality of cells by using carrier aggregation and/or dual connectivity;
a transmission unit that transmits information about support for required conditions when the plurality of transmission points are not co-located; and
a control unit that controls the reception of the downlink signal on the basis of whether the plurality of transmission points are co-located or not.

2. The user terminal according to claim 1, wherein the required conditions when the plurality of transmission points are not co-located relate to a reception timing difference between the plurality of cells and/or a received electric power difference between the plurality of cells.

3. The user terminal according to claim 2, wherein a maximum value of the reception timing difference is larger than a maximum value of the reception timing difference when the plurality of transmission points are co-located.

4. The user terminal according to claim 2, wherein a maximum value of the received electric power difference is larger than a maximum value of the received electric power difference when the plurality of transmission points are co-located.

5. The user terminal according to claim 1, wherein the control unit deduces whether the plurality of transmission points are co-located or not, and controls the reception of the downlink signal on the basis of a result of the deduction.

6. The user terminal according to claim 1, wherein the receiving unit receives information about whether the plurality of transmission points are co-located or not; and the control unit controls the reception of the downlink signal on the basis of the received information.

7. The user terminal according to claim 1, wherein the plurality of cells are provided within a same frequency band.

8. The user terminal according to claim 1, wherein the plurality of cells are a plurality of cells of a same cell group with a same radio access technology (RAT), a plurality of cells of different cell groups with the same RAT, or a plurality of cells respectively belonging to a plurality f cell groups with different RATs.

9. A base station comprising:
a transmission unit that transmits a downlink signal from a plurality of transmission points respectively corresponding to a plurality of cells by using carrier aggregation and/or dual connectivity;
a receiving unit that receives information about support for required conditions when the plurality of transmission points are not co-located; and
a control unit that controls the carrier aggregation or the dual connectivity on the basis of the information about the support.

10. A radio communication method for a user terminal, comprising the steps of:
receiving a downlink signal from a plurality of transmission points respectively corresponding to a plurality of cells by using carrier aggregation and/or dual connectivity;
transmitting information about support for required conditions when the plurality of transmission points are not co-located; and
controlling the reception of the downlink signal on the basis of whether the plurality of transmission points are co-located or not.
